(19) United States
(12) Patent Application Publication
(10) Pub. No.: US 2026/0019744 A1
(43) Pub. Date: Jan. 15, 2026

(54) ADJUSTING AUDIO INPUT IN A VEHICLE

(71) Applicant: Motorola Mobility LLC, Chicago, IL (US)

(72) Inventors: Amit Kumar Agrawal, Bangalore (IN); Panduranga Reddy Pailla, Bangalore (IN); Vijayprakash Idlur, Bangalore (IN)

(73) Assignee: Motorola Mobility LLC, Chicago, IL (US)

(21) Appl. No.: 18/771,640

(22) Filed: Jul. 12, 2024

(51) Int. Cl. H04R 3/00; H04R 3/12

(52) U.S. Cl. CPC H04R 3/005; H04R 3/12

(57) ABSTRACT

In aspects of adjusting audio input in a vehicle, a vehicle audio system implements an audio playback manager that detects a location of a first person in the vehicle, the first person located in proximity of a first microphone device configured to receive audio input for an audio call. The audio playback manager also detects an additional location of a second person in the vehicle, the second person located closer to a second microphone device than the first microphone device, the second microphone device configured to receive the audio input for the audio call. The audio playback manager adjusts the audio input received by at least one of the first microphone device or the second microphone device based on whether the first person or the second person is actively speaking or is a subject of a conversation of the audio call.

### BACKGROUND

Microphone devices may be placed inside a vehicle to receive audio input from passengers. The microphone devices, for example, may be positioned in in a central location, or individually in doors, a dashboard, a rear deck, headrests, or other positions inside the vehicle to receive clear audio input from different passengers throughout the vehicle. This results in an interactive experience during an audio call, allowing any passenger in the vehicle to participate in the audio call.

### BRIEF DESCRIPTION OF THE DRAWINGS

Implementations of the techniques for adjusting audio input in a vehicle are described with reference to the following Figures. The same numbers may be used throughout to reference like features and components shown in the Figures.

FIG. 1 illustrates an example system for adjusting audio input in a vehicle in accordance with one or more implementations as described herein.

FIG. 2 further illustrates an example of adjusting audio input in a vehicle in accordance with one or more implementations as described herein.

FIG. 3 further illustrates an example of adjusting audio input in a vehicle based on whether a person is actively speaking in accordance with one or more implementations as described herein.

FIG. 4 further illustrates an example of adjusting audio input in a vehicle based on whether a person is a subject of a conversation in accordance with one or more implementations as described herein.

FIG. 5 further illustrates an example of adjusting audio input in a vehicle by muting conversations based on detected non-relevant audio in accordance with one or more implementations as described herein.

FIGS. 6-8 illustrate example methods for adjusting audio input in a vehicle in accordance with one or more implementations of the techniques described herein.

FIG. 9 illustrates various components of an example device that may be used to implement the techniques for adjusting audio input in a vehicle as described herein.

### DETAILED DESCRIPTION

Implementations of the techniques for adjusting audio input in a vehicle may be implemented as described herein. A vehicle is equipped with vehicle-to-device communication that enables the vehicle to connect and interact with other devices, such as a mobile device. The mobile device, such as any type of a wireless device, media device, mobile phone, flip phone, client device, tablet, computing, communication, entertainment, gaming, media playback, and/or any other type of computing and/or electronic device, or a system of any combination of such devices, may be configured to perform techniques for adjusting audio input in a vehicle as described herein. In one or more implementations, the vehicle and/or the mobile device includes an audio playback manager, which can be used to implement aspects of the techniques described herein.

Vehicles are commonly equipped with one or more microphone devices, which may positioned at a centralized location or at various locations around the interior of a vehicle. The purpose of this is to receive audio input from inside the vehicle. During an audio call, for instance, the audio call is received or initiated from a mobile device or from an in-vehicle “infotainment” device. Speaker devices located throughout the vehicle may be configured to playback audio output from the audio call (e.g., spoken dialog from somebody on the other end of the audio call), while the microphone devices may be configured to receive the audio input for audio call (e.g., spoken dialog from people inside the vehicle) to facilitate communication via the audio call.

Although the microphone devices allow anybody located inside the vehicle to participate in the audio call, this may not be ideal in some situations. Other people in the vehicle, such as children, may be noisy while others are participating in the audio call, which may be distracting to people on the other end of the audio call. Additionally, unwanted ambient noise, such as traffic noise or engine noise, may be inadvertently received by the microphone devices.

Conventional solutions fail to address these challenges. For example, people inside the vehicle may make a call privately on a mobile device without using the speaker devices and microphone devices inside the vehicle. However, this prevents other people in the vehicle from participating in the audio call, which is inconvenient when more than one person is involved in the conversation. Additionally, it is unsafe and sometimes illegal for a driver of a vehicle to use a mobile device while driving.

Techniques and systems are described for adjusting audio input in a vehicle, which addresses these challenges. This involves identifying locations of people inside the vehicle and adjusting the audio input received from microphone devices based on which people in the vehicle are actively speaking, or based on which people in the vehicle are relevant to the audio call. For example, a driver of a vehicle is actively speaking during an audio call. To prevent unwanted ambient noise from interrupting the audio call, audio input is received from a microphone device nearest to the driver, while other microphone devices are muted. In other example embodiments, an additional person inside the vehicle is determined to be a subject of the conversation of the audio call. In response, the audio input is received from a microphone device nearest to the additional person, while the other microphone devices are muted. This keeps the audio input focused and minimizes unwanted ambient noise or irrelevant audio from interrupting the audio call. These techniques are also an improvement over the conventional solutions, thereby eliminating the need for making a call privately on a mobile device in the vehicle.

A vehicle and/or a connected device (e.g., a mobile device) implements the audio playback manager. In aspects of the described techniques, to determine audio preferences for the people in the vehicle, the audio playback manager first identifies the people in the vehicle. To do this, the audio playback manager receives input from a camera system or a microphone system to detect a location of a first person in the vehicle and a location of a second person in the vehicle. The audio playback manager receives input from the camera device to capture images inside the vehicle and perform facial recognition to identify the first person and at least another person. Alternatively, the audio playback manager receives voice audio captured from the microphone system inside the vehicle and performs voice recognition to identify the first person and the second person based on determined origin locations of the voice audio inside the vehicle.

After detecting the location of the first person in the vehicle and the location of the second person in the vehicle, the audio playback manager may determine which microphone devices correspond to the first person and/or the second person. For example, the vehicle may include multiple microphone devices positioned inside the vehicle that are configurable to receive audio input from different people. A first microphone device, for instance, may be positioned in or near a headrest of a seat of the first person, and a second microphone device may be positioned in or near a headrest of a second person. The location of the first person is therefore closer to the first microphone device than the second microphone device, and the location of the second person is located closer to the second microphone device than the first microphone device. Accordingly, the first microphone device primarily receives audio input from the first person, while the second microphone device primarily receives audio input from the second person.

In this example, the audio playback manager also identifies an active audio call inside the vehicle. For example, the audio playback manager may identify that the audio call is active in the vehicle based on an audio call application being actuated using an “infotainment” device associated with the vehicle or using a mobile device paired with the vehicle.

In an example implementation, the audio playback manager determines whether a person in the vehicle is actively speaking. For example, the audio playback manager identifies whether any of the devices in the vehicle are actively receiving audio input. Based on the previously determined locations of the people in the vehicle, the audio playback manager identifies which person in the vehicle is speaking. To avoid unwanted interruptions while the person is speaking, the audio playback manager adjusts the audio input by only transmitting the audio input received from the microphone device associated with the person who is speaking for the audio call, or mutes other microphone devices in the vehicle while the person is speaking. Alternatively, in example implementations involving the centralized microphone device, the audio playback manager may use the machine learning model to separate the audio input received from the person who is speaking from other audio from the audio input using voice recognition and only transmit the audio input received from the person who is speaking to the audio calling application for communication via the audio call.

In an additional example implementation, the audio call manager determines which person is relevant to the audio call. To do this, the audio call manager determines whether a person in the vehicle is a subject of the conversation of the audio call by detecting names mentioned in the audio output that call attention to a specific person to respond. To avoid unwanted interruptions from other people who are not relevant to the audio call, the audio playback manager adjusts the audio by only transmitting the audio input received from the microphone device associated with the person who is relevant to the audio call, or mutes other microphone devices in the vehicle that are associated with people that are not relevant to the audio call. Alternatively, in example implementations involving the centralized microphone device, the audio playback manager may use the machine learning model to separate the audio input received from the person who is relevant to the audio call from other audio using voice recognition.

In some example implementations, the audio playback manager also adjusts a volume of the speaker devices based on whether a person is a subject of a conversation. For example, the audio playback manager lowers a volume of speaker devices that are directed toward people in the vehicle that are not relevant to the conversation of the audio call. Therefore, the people who are not relevant to the conversation, such as kids in the back of the vehicle, may be excluded from hearing the audio output from the audio call that does not involve them.

While features and concepts of the described techniques for adjusting audio input in a vehicle is implemented in any number of different devices, systems, environments, and/or configurations, implementations of the techniques for adjusting audio input in a vehicle are described in the context of the following example devices, systems, and methods.

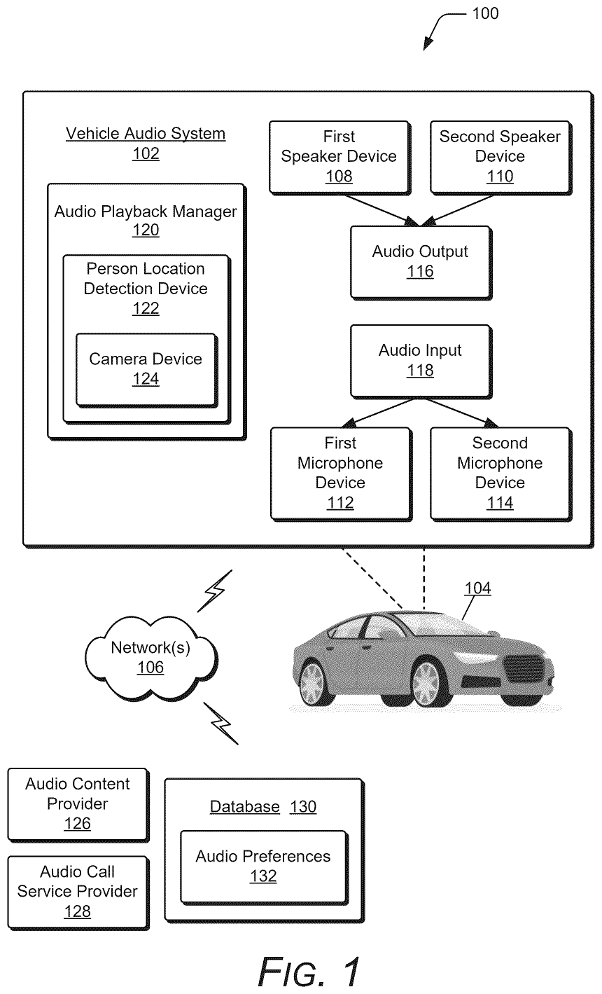

FIG. 1 illustrates an example system 100 for adjusting audio input in a vehicle, as described herein. The system 100 includes a vehicle audio system 102 implemented in a vehicle 104, and a communication network 106. The vehicle audio system 102 includes a speaker system that includes at least a first speaker device 108 and a second speaker device 110, as well as a microphone system that includes at least a first microphone device 112 and a second microphone device 114. The first speaker device 108 and the second speaker device 110 are configured to playback audio output 116 inside the vehicle 104. The audio output 116, for example, may include audio from a voice call or other type of audio received for playback by the vehicle audio system 102. The first microphone device 112 and the second microphone device 114 are configured to receive audio input 118 from inside the vehicle 104. The audio input 118, for example, includes voice audio or ambient noise from inside the vehicle 104. In some examples, the vehicle audio system 102 may also include any type of a wireless device in communication with the vehicle 104, including a mobile device, mobile phone, flip phone, client device, companion device, tablet, computing device, communication device, entertainment device, gaming device, media playback device, any other type of computing and/or electronic device.

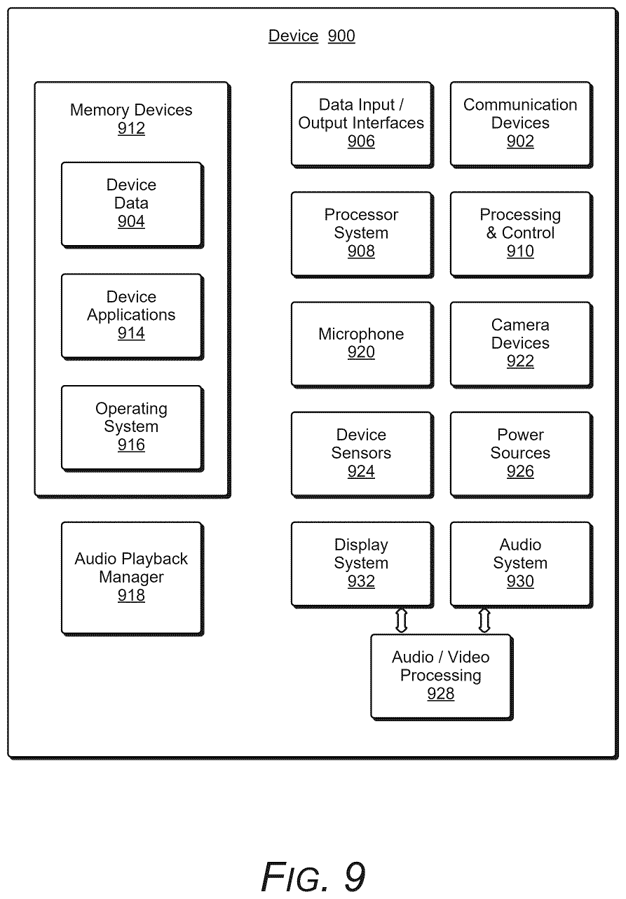

The vehicle audio system 102 can be implemented with various components, such as a processor system and memory, as well as any number and combination of different components as further described with reference to the example device shown in FIG. 9. In implementations, the vehicle audio system 102 may include various radios for wireless communication with other devices. For example, the system and devices can include a Bluetooth (BT) and/or Bluetooth Low Energy (BLE) transceiver, as well as a near field communication (NFC) transceiver. In some cases, the system and devices include at least one of a Wi-Fi radio, a cellular radio, a global positioning satellite (GPS) radio, or any available type of device communication interface.

In some implementations, the vehicle 104, the devices, applications, modules, servers, and/or services described herein communicate via the communication network 106, such as for data communication with the vehicle audio system 102. The communication network 106 includes a wired and/or a wireless network. The communication network 106 is implemented using any type of network topology and/or communication protocol, and is represented or otherwise implemented as a combination of two or more networks, to include IP-based networks, cellular networks, and/or the Internet. The communication network 106 includes mobile operator networks that are managed by a mobile network operator and/or other network operators, such as a communication service provider, mobile phone provider, and/or Internet service provider. In one or more examples, the vehicle audio system 102 is capable of interconnecting and interfacing with other devices and/or networks, such as the communication network 106 via wireless and/or wired connectivity.

In the example system 100 for adjusting audio input in a vehicle, the vehicle audio system 102 implements an audio playback manager 120. As shown in this example, the audio playback manager 120 represents functionality (e.g., logic, software, and/or hardware) enabling aspects of the described techniques for adjusting audio input in a vehicle. The audio playback manager 120 can be implemented as computer instructions stored on computer-readable storage media and can be executed by a processor system of the vehicle audio system 102. Alternatively, or in addition, the audio playback manager 120 can be implemented at least partially in hardware of the device.

In one or more implementations, the audio playback manager 120 includes independent processing, memory, and/or logic components functioning as a computing and/or electronic device integrated with the vehicle audio system 102. Alternatively, or in addition, the audio playback manager 120 can be implemented in software, in hardware, or as a combination of software and hardware components. In this example, the audio playback manager 120 is implemented as a software application or module, such as executable software instructions (e.g., computer-executable instructions) that are executable with a processor system of the vehicle audio system 102 to implement the techniques and features described herein. As a software application or module, the audio playback manager 120 can be stored on computer-readable storage memory (e.g., memory of a device), or in any other suitable memory device or electronic data storage implemented with the controller. Alternatively or in addition, the audio playback manager 120 is implemented in firmware and/or at least partially in computer hardware. For example, at least part of the audio playback manager 120 is executable by a computer processor, and/or at least part of the content manager is implemented in logic circuitry.

In this example system 100, the audio playback manager 120 detects a location of a first person in the vehicle 104 and a location of a second person in the vehicle 104. For example, the vehicle 104 may include multiple seats inside the vehicle 104, where multiple people may be seated for a duration of a ride in the vehicle 104. To detect the location of the first person in the vehicle 104 and the location of the second person in the vehicle 104, the vehicle audio system 102 includes a person location detection device 122, which may include a camera device 124. The camera device 124, for instance, may be integrated in a rearview mirror to capture images of an internal passenger area of the vehicle 104. The person location detection device 122 may use the camera device 124, for instance, to capture images inside the vehicle 104 to perform facial recognition to identify the first person and the second person. In another example implementation, the person location detection device 122 may receive weight sensor data from weight sensors in seat in the vehicle 104 to detect people seated in the vehicle 104.

In another example implementation, the audio playback manager 120 detects the location of the first person in the vehicle 104 and the location of the second person in the vehicle 104 based on voice recognition. For instance, the first microphone device 112 and the second microphone device 114 receive the audio input 118, which may include spoken audio from people in the vehicle 104, such as voice commands or ambient conversational audio. The audio playback manager 120 compares the audio input 118 to known voice characteristics for particular people and matches an identified voice with a particular microphone device. In an example, for instance, the first person is speaking in the vehicle 104. Because the first microphone device 112 receives the audio input 118 at a higher volume than the second microphone device 114, the audio playback manager 120 determines that the first person is located closer to the first microphone device 112. Based on this, and based on a predetermined map of the vehicle 104, the audio playback manager 120 determines the location of the first person in the vehicle 104 and the location of the second person in the vehicle 104.

After detecting the location of the first person in the vehicle 104 and the location of the second person in the vehicle 104, the vehicle audio system 102 determines which microphone devices correspond to the first person or the second person. For example, the location of the first person is in proximity of the first microphone device 112, and the location of the second person is in proximity of the second microphone device 114. The location of the first person is located closer to the first microphone device 112 than the second microphone device 114, and the location of the second person is located closer to the second microphone device 114 than the first microphone device 112. In other words, the first microphone device 112 primarily receives the audio input 118 from the first person, and the second microphone device 114 primarily receives the audio input 118 from the second person. In other examples, however, a centralized microphone device may be capable of selectively receiving the audio input 118 from individual people inside the vehicle 104.

In this example, the audio playback manager 120 also identifies the audio output 116 being output by the first speaker device 108 and the second speaker device 110. The audio output 116, for example, may be provided by an audio content provider 126 accessible via the communication network 106. In this example, the audio playback manager 120 identifies that, based on the audio output 116, an audio call is in session inside the vehicle 104, hosted by an audio call service provider 128 accessible via the communication network 106. For instance, the audio playback manager 120 may determine that the audio call is in session based on an active calling application accessed via an in-vehicle “infotainment” system of the vehicle 104, or based on detected audio related to an audio call.

Because audio calls are often interrupted by ambient noise or non-relevant audio spoken by nearby people, the audio playback manager 120 adjusts the audio input 118 based on which person is actively speaking in the vehicle 104 or based on which person is relevant to the audio call. To determine which person is actively speaking in the vehicle 104, the audio playback manager 120 identifies whether either of the first microphone device 112 or the second microphone device 114 is actively receiving the audio input 118. For instance, the first microphone device 112 is actively receiving the audio input 118, and because the audio playback manager 120 previously determined the location of the first person in the vehicle 104 is in a proximity of the first microphone device 112, the audio playback manager 120 determines that the first person is actively speaking. Alternatively, in example implementations involving the centralized microphone device, the audio playback manager 120 may use the voice recognition to determine which person is actively speaking in the vehicle 104.

The audio playback manager 120 then adjusts the audio input 118 received by the first microphone device 112 or the second microphone device 114 based on which person is actively speaking in the vehicle 104. For instance, to reduce unwanted ambient noise from being input to the voice call, the audio playback manager 120 may remove part of the audio input 118 received from microphones that are not being actively spoken into, or mute the other microphones. In this example, because the first person is actively speaking in the proximity of the first microphone device 112, the audio playback manager 120 may block input of the audio input 118 received by the second microphone device 114 from contribution to the audio call, or mute the second microphone device 114 while the first person is actively speaking.

Alternatively or in addition, to determine which person is relevant to the audio call, the audio playback manager 120 may determine which person is a subject of a conversation of the audio call. To determine which person is the subject of the conversation of the audio call, the audio playback manager 120 detects whether a name of one of the people inside the vehicle 104 is spoken during the conversation of the audio call. For instance, because the audio playback manager 120 previously determined the location of the first person in the vehicle 104 is in the proximity of the first microphone device 112 and the second person in the vehicle 104 is in the proximity of the second microphone device 114, the audio playback manager 120 detects whether the name of the first person or the name of the second person is mentioned in the conversation. For instance, the audio playback manager 120 determines whether the audio output 116 mentions the name, or whether the audio input 118 spoken by a person inside the vehicle 104 mentions the name. Alternatively or in addition, the audio playback manager 120 may determine which person is the subject of the conversation of the audio call based on whether the first person or the second person is relevant to a context of the audio call. For example, the audio call is directed to a mobile device associated with the first person, or the vehicle 104 is associated with the first person.

In some example embodiments, the audio playback manager 120 accesses a database 130 of audio preferences 132 via the communication network 106 to determine which person is relevant to the audio call. For example, the database 130 of the audio preferences 132 may specify people that are relevant to types of audio calls or audio calls communicating with devices associated with specific people.

The audio playback manager 120 then adjusts the audio input 118 received by the first microphone device 112 or the second microphone device 114 based on which person is relevant to the audio call in the vehicle 104. For instance, to reduce unwanted ambient noise from being input to the voice call, the audio playback manager 120 may remove part of the audio input 118 received from microphones that are associated with irrelevant people to the audio call, or mute the other microphones. In this example, because the first person is relevant to the audio call and is in the proximity of the first microphone device 112, the audio playback manager 120 mutes the second microphone device 114.

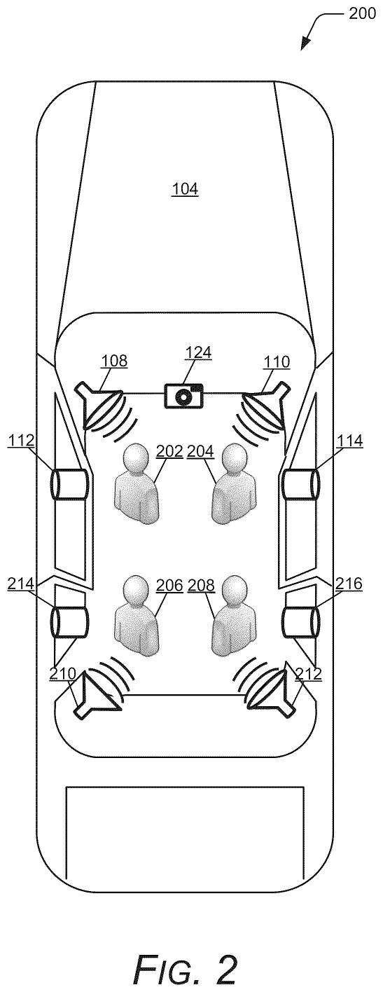

FIG. 2 illustrates example 200 of adjusting audio input in a vehicle. In this example 200, the audio playback manager 120 detects locations of a first person 202, a second person 204, a third person 206, and a fourth person 208 in a vehicle 104. For example, the first person 202, the second person 204, the third person 206, and the fourth person 208 are seated in different seats of vehicle 104. Although this example involves four people, the vehicle 104 may include any number of people in other examples.

To detect the locations of the first person 202, the second person 204, the third person 206, and the fourth person 208, the audio playback manager 120 may employ a person location detection device 122, which may use a camera device 124 or other sensor to identify people in the vehicle 104. In this example, the audio playback manager 120 receives images of faces of the people in the vehicle 104 captured by the camera device 124

For instance, the camera device 124 captures images of a faces of the first person 202, the second person 204, the third person 206, and the fourth person 208. The person location detection device 122 then applies a facial recognition model to the images of the faces. Based on the facial recognition model, the person location detection device 122 determines identities for the first person 202, the second person 204, the third person 206, and the fourth person 208. Additionally, the audio playback manager 120 may determine which seat or position of the vehicle 104 the first person 202, the second person 204, the third person 206, and the fourth person 208 are located based on additional images or camera angles of images captured inside the vehicle 104 by the camera device 124. For example, an image captured of the first person 202 from a particular angle indicates that the first person 202 is seated in a driver's seat of the vehicle 104.

The vehicle 104 is equipped with a speaker system and a microphone system. In this example, the speaker system includes a first speaker device 108, a second speaker device 110, a third speaker device 210, and a fourth speaker device 212. The speakers of the speaker system receive electrical signals corresponding to audio input 118 and convert the electrical signals into sound. Additionally, in this example, the microphone system includes a first microphone device 112, a second microphone device 114, a third microphone device 214, and a fourth microphone device 216. Although this example includes four speaker devices and four microphone devices, the vehicle 104 may include any number of speaker devices or microphone devices.

The first microphone device 112, the second microphone device 114, the third microphone device 214, and the fourth microphone device 216 may be positioned in doors, a dashboard, an overhead console, a rear deck, headrests, or other positions inside the vehicle to receive the audio input 118 originating from any location inside the vehicle 104, such as voice commands or audible dialog during an audio call. For instance, during the audio call, the first speaker device 108, the second speaker device 110, and third speaker device 210, and the fourth speaker device 212 output the audio output 116 related to the audio call (e.g., audible dialog from the other person on the call, who is not inside the vehicle 104) for playback, and the first microphone device 112, the second microphone device 114, and third microphone device 214, and the fourth microphone device 216 receive the audio input 118 related to the audio call (e.g., audible dialog from the people inside the vehicle 104).

The microphones of the microphone system may be positioned inside the vehicle 104 to receive audio input 118 from specific seats of the vehicle 104. For example, particular microphones are located closer to particular seats of the vehicle 104 to receive the audio input 118 from the people seated in the particular seats. In this example, the first microphone device 112 is positioned closer to a seat where the first person 202 is located than seats where the second person 204, the third person 206, or the fourth person 208 are located. The second microphone device 114 is positioned closer to a seat where the second person 204 is located than seats where the first person 202, the third person 206, or the fourth person 208 are located. The third microphone device 214 is positioned closer to a seat where the third person 206 is located than seats where the first person 202, second person 204, or the fourth person 208 are located. The fourth microphone device 216 is positioned closer to a seat where the fourth person 208 is located than seats where the first person 202, second person 204, or the third person 206 are located.

Because the first microphone device 112, the second microphone device 114, the third microphone device 214, and the fourth microphone device 216 may be directed to receiving the audio input 118 from different regions of the vehicle 104, the audio playback manager 120 may adjust the audio input 118 to reduce emphasis on receiving the audio input 118 from regions of the vehicle 104 with non-relevant or distracting audio. For instance, the audio playback manager 120 may block input of the audio input 118 received by a particular microphone or may mute a particular microphone.

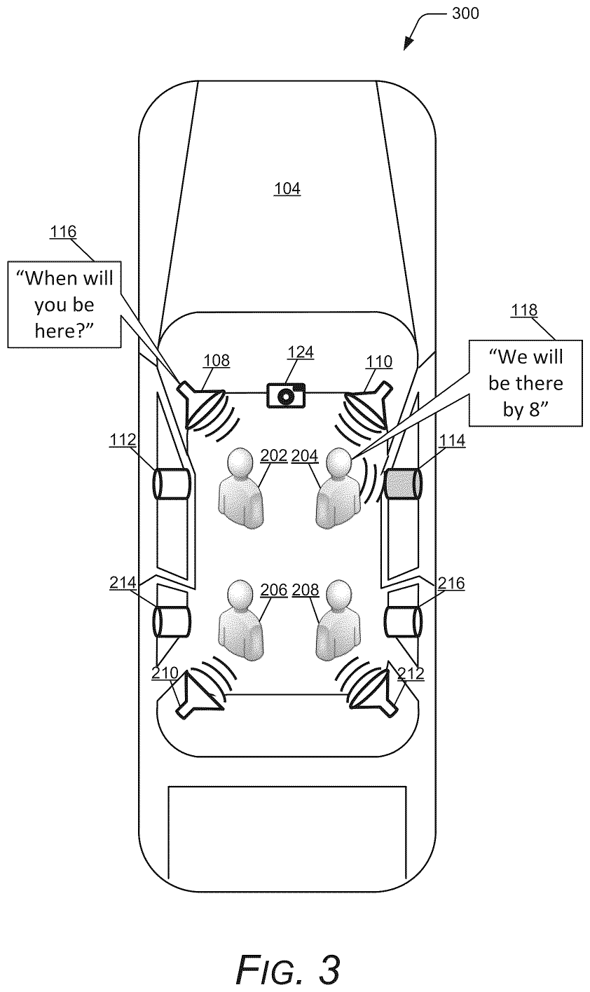

FIG. 3 illustrates example 300 of adjusting audio input in a vehicle based on whether a person is actively speaking. The example 300 is a continuation of the example 200. In this example 300, the audio playback manager 120 adjusts the audio input 118 received by the second microphone device 114 based on detecting that the second person 204 is actively speaking.

To determine which person is actively speaking, the audio playback manager 120 detects the locations of the first person 202, the second person 204, the third person 206, and the fourth person 208 using the person location detection device 122 described with respect to example 200, which may use the camera device 124 or other sensor to identify the people in the vehicle 104. For example, based on captured images of faces of the people in the vehicle 104, the person location detection device 122 applies a facial recognition model to the faces. Based on the facial recognition model, the person location detection device 122 determines identities for the first person 202, the second person 204, the third person 206, and the fourth person 208. Additionally, the audio playback manager 120 may determine which seat or position of the vehicle 104 the first person 202, the second person 204, the third person 206, and the fourth person 208 are located in based on additional images or camera angles of images captured inside the vehicle 104 by the camera device 124. For example, an image captured of the first person 202 from a particular angle indicates that the first person 202 is seated in a driver's seat of the vehicle 104.

The vehicle 104 in this example implementation is equipped with a first microphone device 112, a second microphone device 114, a third microphone device 214, and a fourth microphone device 216 positioned inside the vehicle 104 receive the audio input 118 from regions near specific seats of the vehicle 104. In this example, the first microphone device 112 is positioned closer to a seat where the first person 202 is located than seats where the second person 204, the third person 206, or the fourth person 208 are located. The third microphone device 214 is positioned closer to a seat where the second person 204 is located than seats where the first person 202, the third person 206, or the fourth person 208 are located. The third microphone device 214 is positioned closer to a seat where the third person 206 is located than seats where the first person 202, second person 204, or the fourth person 208 are located. The fourth microphone device 216 is positioned closer to a seat where the fourth person 208 is located than seats where the first person 202, second person 204, or the third person 206 are located.

Therefore, the first microphone device 112, the second microphone device 114, the third microphone device 214, and the fourth microphone device 216 are equipped to receive the audio input 118 from different regions throughout the vehicle 104. In some situations, however, the audio input 118 includes both relevant and irrelevant audio, which may originate from different regions of the vehicle 104. For this reason, the audio playback manager 120 selectively adjusts the audio input 118 and/or the microphones based on whether a person is actively speaking during an audio call or is relevant to an audio call.

To do this, the audio playback manager 120 identifies that an audio call is active in the vehicle 104. In an example implementation, the audio playback manager 120 may identify that the audio call is active in the vehicle 104 based on an audio call application being actuated using an “infotainment” device associated with the vehicle 104 or using a mobile device paired with the vehicle 104. In an additional example implementation, the audio playback manager 120 may identify that the audio call is active in the vehicle 104 based on detecting call-related audio received from the first microphone device 112, the second microphone device 114, the third microphone device 214, or the fourth microphone device 216 in the vehicle 104.

In this example, the audio playback manager 120 identifies that an audio call is active in the vehicle 104. An incoming audio call, for instance, is received using an audio calling application on a mobile device paired with the vehicle 104. The mobile device in this example is associated with the first person 202. Because the mobile device is paired with the vehicle 104, the audio output 116 from the audio call of the audio calling application is output via the first speaker device 108, the second speaker device 110, the third speaker device 210, and the fourth speaker device 212. Likewise, the audio input 118 for the audio call of the audio calling application is received via the first microphone device 112, the second microphone device 114, the third microphone device 214, and the fourth microphone device 216. In this example, the audio output 116 spoken by the caller is output for playback by the speakers in the vehicle 104, asking the people in the vehicle 104 “when will you be here?”

The audio playback manager 120 then determines whether a person in the vehicle 104 is actively speaking. To determine which person is actively speaking in the vehicle 104, the audio playback manager 120 identifies whether any of the first microphone device 112, the second microphone device 114, the third microphone device 214, or the fourth microphone device 216 are actively receiving the audio input 118. Based on the previously determined locations of the people in the vehicle 104, the audio playback manager 120 determines which person is speaking. Alternatively, in example implementations involving the centralized microphone device, the audio playback manager 120 may use the voice recognition to determine which person is actively speaking in the vehicle 104. For instance, in some example implementations, the audio playback manager 120 employs a machine learning model to determine which person is actively speaking in the vehicle 104. The machine learning model is trained on voice samples or call history data of the people inside the vehicle 104 to perform the voice recognition.

In this example, the audio playback manager 120 determines that the second person 204 is actively speaking. This is because the second microphone device 114 receives the audio input 118 “we will be there by 8.” Because the audio input 118 is received more heavily by the second microphone device 114 than the first microphone device 112, the third microphone device 214, or the fourth microphone device 216, the audio playback manager 120 determines that the audio input 118 is actively spoken by the person nearest to the second microphone device 114. Based on previously determined locations of the people in the vehicle 104, the audio playback manager 120 determines that the second person 204 is actively speaking, because the second person 204 is sitting nearest to the second microphone device 114.

The audio playback manager 120 then adjusts the audio input 118 by only transmitting the audio input 118 received from the second microphone device 114 to the audio calling application for the audio call. This way, the caller on the other end of the audio call only hears the second person 204 say “we will be there by 8,” instead of also hearing unwanted ambient noise, such as traffic noise or engine noise. Alternatively, in example implementations involving the centralized microphone device, the audio playback manager 120 may use the machine learning model to separate the audio input 118 received from the second person 204 from other audio from the audio input 118 and only transmit the audio input 118 received from the second person 204 to the audio calling application for communication via the audio call.

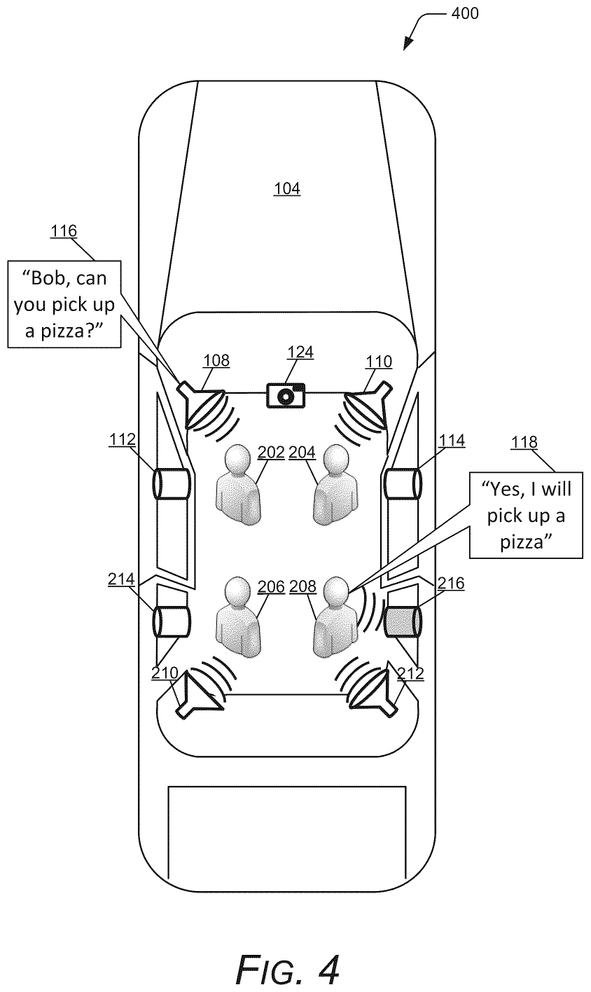

FIG. 4 illustrates example 400 of adjusting audio input in a vehicle based on whether a person is a subject of a conversation. The example 400 is a continuation of the example 300. In this example 400, the audio playback manager 120 adjusts the audio input 118 received by the second microphone device 114 based on detecting that the fourth person 208 is the subject of the conversation.

As described with respect to FIG. 3 in the example 300, the audio playback manager 120 adjusts the audio input 118 by only transmitting the audio input 118 received from the second microphone device 114 to the audio calling application for the audio call. This way, the caller on the other end of the audio call only hears the second person 204 respond, instead of also hearing unwanted ambient noise, such as traffic noise or engine noise.

In this example 400, however, the second person 204 stops speaking, and the subject of the conversation changes. For example, the caller asks “Bob, can you pick up the pizza?” which is output via the speakers. Because this question triggers a change in the conversation of the audio call, the audio playback manager 120 re-adjusts the audio input 118 to the microphones in the vehicle 104 based on which person is expected to respond in the conversation.

In this example 400, the first person 202, the second person 204, the third person 206, and the fourth person 208 remain in their respective seats in the vehicle 104. However, in some example implementations the people change positions in the vehicle 104. In response to detecting a change in the conversation, the audio playback manager 120 again detects the locations of the first person 202, the second person 204, the third person 206, and the fourth person 208 using the person location detection device 122 described with respect to example 200, which may use the camera device 124 or other sensor to identify the people in the vehicle 104.

As discussed with respect to FIG. 3 in the example 300, the vehicle 104 in this example implementation is equipped with a first microphone device 112, a second microphone device 114, a third microphone device 214, and a fourth microphone device 216 positioned inside the vehicle 104 receive the audio input 118 from regions near specific seats of the vehicle 104. In this example, the first microphone device 112 is positioned closer to a seat where the first person 202 is located than seats where the second person 204, the third person 206, or the fourth person 208 are located. The third microphone device 214 is positioned closer to a seat where the second person 204 is located than seats where the first person 202, the third person 206, or the fourth person 208 are located. The third microphone device 214 is positioned closer to a seat where the third person 206 is located than seats where the first person 202, second person 204, or the fourth person 208 are located. The fourth microphone device 216 is positioned closer to a seat where the fourth person 208 is located than seats where the first person 202, second person 204, or the third person 206 are located.

Therefore, the first microphone device 112, the second microphone device 114, the third microphone device 214, and the fourth microphone device 216 are equipped to receive the audio input 118 from different regions throughout the vehicle 104. In some situations, however, the audio input 118 includes both relevant and irrelevant audio, which may originate from different regions of the vehicle 104. Therefore, the audio playback manager 120 selectively adjusts the audio input 118 and/or the microphones based on whether a person is relevant to an audio call.

In this example, the audio playback manager 120 identifies that an audio call is still active in the vehicle 104. The incoming audio call received using the audio calling application on the mobile device paired with the vehicle 104, for instance, is still in progress. The audio output 116 spoken by the caller is output for playback by the speakers in the vehicle 104, now asking the people in the vehicle 104 “Bob, can you pick up a pizza?”

Because the audio output 116 is directed toward a specific person in the vehicle 104 (i.e., “Bob”), the audio playback manager 120 determines which person is relevant to the audio call by identifying a subject of the audio call. To determine which person is the subject of the audio call, the audio playback manager 120 identifies names mentioned in the audio output 116 that call attention to a specific person to respond. For instance, because the audio playback manager 120 previously determined the location of the first person 202 is in the proximity of the first microphone device 112, the second person 204 is in the proximity of the second microphone device 114, the third person 206 is in the proximity of the third microphone device 214, and the fourth person 208 is in the proximity of the fourth microphone device 216, the audio playback manager 120 detects whether the name of the first person 202, the second person 204, the third person 206, or the fourth person 208 is mentioned in the conversation. Alternatively, the audio playback manager 120 may use the machine learning model to determine which person is the subject of the conversation based on a context of the audio call. For example, the machine learning model may be trained on labeled datasets of prior audio calls and context determinations to accurately determine which person is the subject of the conversation, even when the person's name is not mentioned during the audio call. In some example implementations, the audio playback manager 120 determines which person is the subject of the conversation based on which person is associated with the mobile device facilitating the audio call, or which person is associated with the vehicle 104.

In this example, the audio playback manager 120 determines that the fourth person 208 is the subject of the conversation and is therefore relevant to the audio call. This is because the audio output 116 includes the question “Bob, can you pick up a pizza?” which is directed to somebody named “Bob” in the vehicle 104. Based on previously determined locations of the people in the vehicle 104, the audio playback manager 120 determines that the fourth person 208 is “Bob” and is therefore relevant to the audio call.

The audio playback manager 120 then adjusts the audio input 118 by only transmitting the audio input 118 received from the fourth microphone device 216 to the audio calling application for the audio call. This way, the caller on the other end of the audio call only hears the fourth person 208 say “yes, I will pick up the pizza,” instead of also hearing unwanted ambient noise, such as traffic noise or engine noise. Alternatively, in example implementations involving the centralized microphone device, the audio playback manager 120 may use the machine learning model to separate the audio input 118 received from the fourth person 208 from other audio from the audio input 118 and only transmit the audio input 118 received from the fourth person 208 to the audio calling application for communication via the audio call.

In some example implementations, the audio playback manager 120 also adjusts a volume of the speaker devices based on whether a person is a subject of a conversation. In this example, the audio playback manager 120 adjusts the audio output 116 by lowering a volume of the first speaker device 108, the second speaker device 110 and the third speaker device 210 based on detecting that the fourth person 208 is the subject of the conversation. This is because the fourth person 208 is the subject of the conversation, and therefore only the fourth person 208 is involved with the audio call and listens to the audio output 116 from the other caller via the fourth speaker device 212 that is associated with the fourth person 208. Therefore, the first person 202, the second person 204, and the third person 206 may be excluded from hearing the audio output 116 from the audio call that involves the fourth person 208.

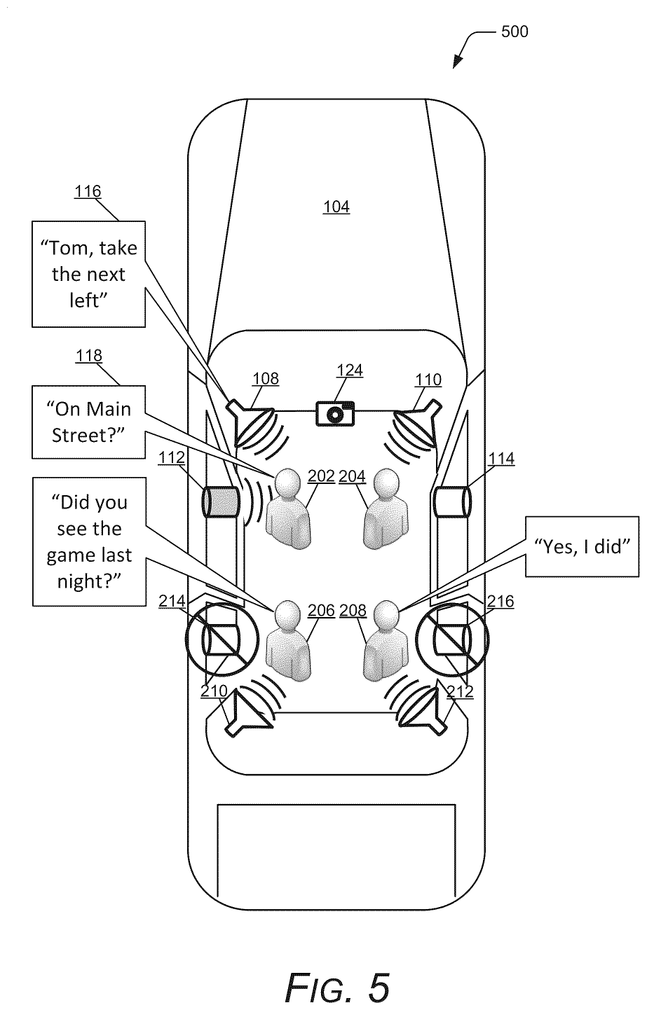

FIG. 5 illustrates example 500 of adjusting audio input in a vehicle by muting conversations based on detected non-relevant audio. The example 500 is a continuation of the example 400. In this example 500, the audio playback manager 120 mutes the third microphone device 214 and the fourth microphone device 216 based on detected non-relevant audio from the third person 206 and the fourth person 208.

As described with respect to FIG. 4 in the example 400, the audio playback manager 120 adjusts the audio input 118 by only transmitting the audio input 118 received from the fourth microphone device 216 to the audio calling application for the audio call. Because of this, the caller on the other end of the audio call only hears the fourth person 208 say “yes, I will pick up the pizza,” instead of also hearing unwanted ambient noise, such as traffic noise or engine noise.

In this example 500, however, the fourth person 208 stops speaking, and the subject of the conversation changes again. For example, the caller says “Tom, take the next left” which is output via the speakers. Because this question triggers a change in the conversation of the audio call, the audio playback manager 120 re-adjusts the audio input 118 to the microphones in the vehicle 104 based on which person is expected to respond in the conversation.

In this example 500, the first person 202, the second person 204, the third person 206, and the fourth person 208 remain in their respective seats in the vehicle 104. However, in some example implementations the people change positions in the vehicle 104. In response to detecting a change in the conversation, the audio playback manager 120 again detects the locations of the first person 202, the second person 204, the third person 206, and the fourth person 208 using the person location detection device 122 described with respect to example 200, which may use the camera device 124 or other sensor to identify the people in the vehicle 104.

As discussed with respect to FIG. 3 in the example 300, the vehicle 104 in this example implementation is equipped with a first microphone device 112, a second microphone device 114, a third microphone device 214, and a fourth microphone device 216 positioned inside the vehicle 104 receive the audio input 118 from regions near specific seats of the vehicle 104. In this example, the first microphone device 112 is positioned closer to a seat where the first person 202 is located than seats where the second person 204, the third person 206, or the fourth person 208 are located. The third microphone device 214 is positioned closer to a seat where the second person 204 is located than seats where the first person 202, the third person 206, or the fourth person 208 are located. The third microphone device 214 is positioned closer to a seat where the third person 206 is located than seats where the first person 202, second person 204, or the fourth person 208 are located. The fourth microphone device 216 is positioned closer to a seat where the fourth person 208 is located than seats where the first person 202, second person 204, or the third person 206 are located.

Therefore, the first microphone device 112, the second microphone device 114, the third microphone device 214, and the fourth microphone device 216 are equipped to receive the audio input 118 from different regions throughout the vehicle 104. In some situations, however, the audio input 118 includes both relevant and irrelevant audio, which may originate from different regions of the vehicle 104. Therefore, the audio playback manager 120 selectively adjusts the audio input 118 and/or the microphones based on whether a person is relevant to an audio call.

In this example, the audio playback manager 120 identifies that an audio call is still active in the vehicle 104. The incoming audio call received using the audio calling application on a mobile device paired with the vehicle 104, for instance, is still in progress. The audio output 116 spoken by the caller is output for playback by the speakers in the vehicle 104, now saying “Tom, take the next left.”

Because the audio output 116 is directed toward a specific person in the vehicle 104 (i.e., “Tom”), the audio playback manager 120 determines which person is relevant to the audio call by identifying a subject of the audio call. To determine which person is the subject of the audio call to the audio call, the audio playback manager 120 identifies names mentioned in the audio output 116 that call attention to a specific person to respond. For instance, because the audio playback manager 120 previously determined the location of the first person 202 is in the proximity of the first microphone device 112, the second person 204 is in the proximity of the second microphone device 114, the third person 206 is in the proximity of the third microphone device 214, and the fourth person 208 is in the proximity of the fourth microphone device 216, the audio playback manager 120 detects whether the name of the first person 202, the second person 204, the third person 206, or the fourth person 208 is mentioned in the conversation. Alternatively, the audio playback manager 120 may use the machine learning model to determine which person is the subject of the conversation based on a context of the audio call. For example, the machine learning model may be trained on labeled datasets of prior audio calls and context determinations to accurately determine which person is the subject of the conversation, even when the person's name is not mentioned during the audio call. In some example implementations, the audio playback manager 120 determines which person is the subject of the conversation based on which person is associated with the mobile device facilitating the audio call, or which person is associated with the vehicle 104.

In this example, the audio playback manager 120 determines that the first person 202 is the subject of the conversation and is therefore relevant to the audio call. This is because the audio output 116 includes the directions “Tom, take the next left” which is directed to somebody named “Tom” in the vehicle 104. Based on previously determined locations of the people in the vehicle 104, the audio playback manager 120 determines that the first person 202 is “Tom” and therefore relevant to the audio call.

However, the audio playback manager 120 also detects non-relevant audio in the vehicle 104. For example, the audio playback manager 120 may detect audio spoken by other people in the vehicle 104 that are not relevant to the audio call. In this example, the third person 206 asks “Did you see the game last night?” and the fourth person 208 responds “Yes, I did.” This non-relevant audio is distracting to the caller and obscures the response of the first person 202 to the caller of the audio call.

The audio playback manager 120 then adjusts the audio input 118 by muting the microphones that are receiving the non-relevant audio. In this example, the audio playback manager 120 mutes the third microphone device 214, which corresponds to the third person 206, and the fourth microphone device 216, which corresponds to the fourth person 208. This way, the caller on the other end of the audio call only hears the first person 202 ask “On Main Street?,” which is relevant to the audio call instead of also hearing non-relevant audio, such as the conversation between the third person 206 and the fourth person 208. Alternatively, in example implementations involving the centralized microphone device, the audio playback manager 120 may use the machine learning model to separate the audio input 118 received from the first person 202 from other audio from the audio input 118 and only transmit the audio input 118 received from the first person 202 to the audio calling application for communication via the audio call.

In some example implementations, the audio playback manager 120 also adjusts a volume of the speaker devices based on whether a person is a subject of a conversation. In this example, the audio playback manager 120 adjusts the audio output 116 by lowering a volume of the second speaker device 110, the third speaker device 210, and the fourth speaker device 212 based on detecting that the first person 202 is the subject of the conversation. This is because the first person 202 is the subject of the conversation, and therefore only the first person 202 is involved with the audio call and listens to the audio output 116 from the other caller via the first speaker device 108 that is associated with the fourth person 208. Therefore, the second person 204, the third person 206, and the fourth person 208 may be excluded from hearing the audio output 116 from the audio call that involves the first person 202.

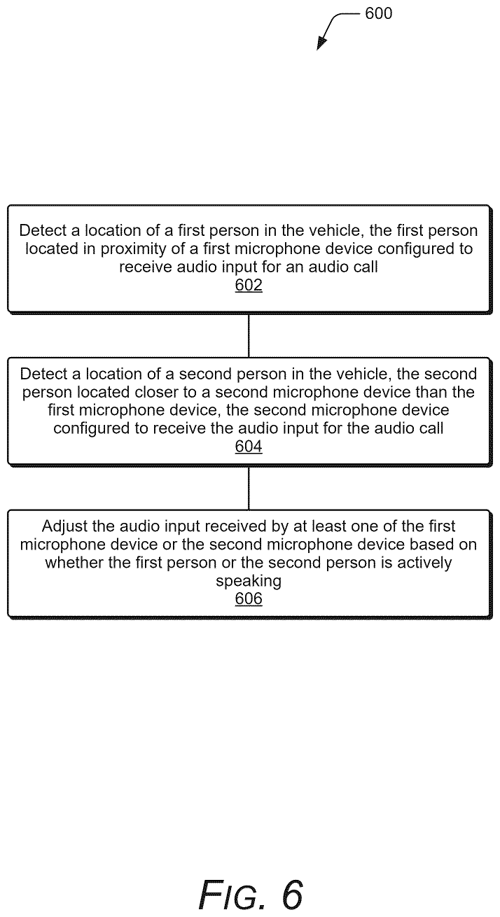

Example methods 600, 700, and 800 are described with reference to respective FIGS. 6, 7, and 8 in accordance with one or more implementations of adjusting audio input in a vehicle, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 6 illustrates example method(s) 600 for adjusting audio input in a vehicle. The order in which the method is described is not intended to be construed as a limitation, and any number or combination of the described method operations may be performed in any order to perform a method, or an alternate method.

At 602, a location of a first person is detected in a vehicle, the first person located in proximity of a first microphone device configured to receive audio input for an audio call. For example, the audio playback manager 120 detects a location of a first person 202 in the vehicle 104, the first person 202 located in proximity of a first microphone device 112 configured to receive audio input 118 for an audio call.

At 604, a location of a second person is detected in the vehicle, the second person located closer to a second microphone device than the first microphone device, the second microphone device configured to receive the audio input for the audio call. For example, the audio playback manager 120 detects a location of a second person 204 in the vehicle 104, the second person located closer to a second microphone device 114 than the first microphone device 112, the second microphone device 114 configured to receive the audio input 118 for the audio call. In some example implementations, the audio playback manager 120 uses voice recognition to detect at least one of the location of the first person 202 in the vehicle 104 or the additional location of the second person 204 in the vehicle 104. In other example implementations, the audio playback manager 120 uses facial recognition to detect at least one of the location of the first person 202 in the vehicle 104 or the additional location of the second person 204 in the vehicle 104.

At 606, the audio input received by at least one of the first microphone device or the second microphone device is adjusted based on whether the first person or the second person is actively speaking. For example, the audio playback manager 120 adjusts the audio input 118 received by at least one of the first microphone device 112 or the second microphone device 114 based on whether the first person 202 or the second person 204 is actively speaking. In some example implementations, the audio playback manager 120 mutes the first microphone device 112 when the first person 202 is not actively speaking. For example, the audio playback manager 120 detects when the first person 202 begins actively speaking and un-mutes the first microphone device 112. In some example implementations, the audio playback manager 120 determines whether the first person 202 or the second person 204 is relevant to the audio call. For example, the audio playback manager 120 uses a machine learning model trained on prior call history to determine whether the first person 202 or the second person 204 is relevant to the audio call. In some example implementations, the audio playback manager 120 further adjusts at least one of the audio input 118 from the first microphone device 112 or the second microphone device 114 in response to a change in the audio call.

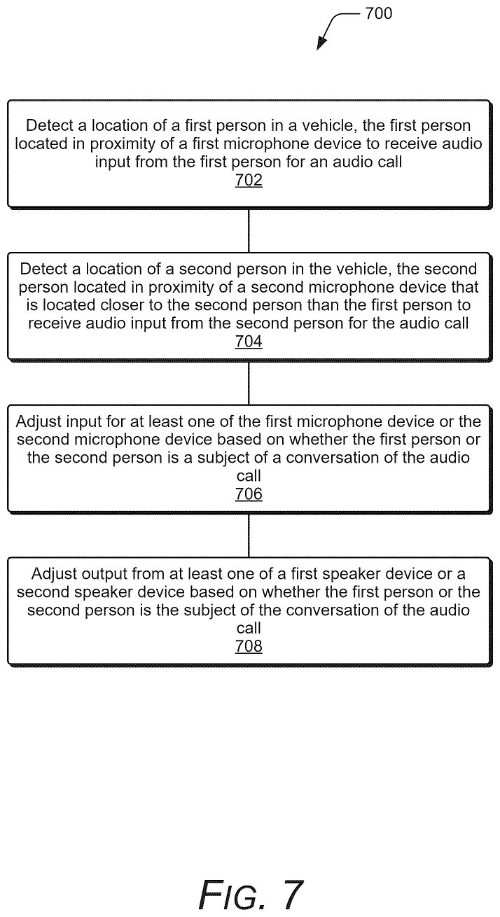

FIG. 7 illustrates example method(s) 700 for adjusting audio input in a vehicle. The order in which the method is described is not intended to be construed as a limitation, and any number or combination of the described method operations may be performed in any order to perform a method, or an alternate method.

At 702, a location of a first person is detected in a vehicle, the first person located in proximity of a first microphone device to receive audio input from the first person for an audio call. For example, the audio playback manager 120 detects a location of a first person 202 in a vehicle 104, the first person 202 located in proximity of a first microphone device 112 to receive audio input 118 from the first person 202 for an audio call.

At 704, a location of a second person is detected in the vehicle, the second person located in proximity of a second microphone device that is located closer to the second person than the first person to receive audio input from the second person for the audio call. For example, the audio playback manager 120 detects a location of a second person 204 in the vehicle 104, the second person 204 located in proximity of a second microphone device 114 that is located closer to the second person 204 than the first person 202 to receive audio input 118 from the second person 204 for the audio call. In some example implementations, the audio playback manager 120 uses voice recognition to detect the location of the first person 202 in the vehicle 104 or the additional location of the second person 204 in the vehicle 104. In other example implementations, the audio playback manager 120 uses facial recognition to detect the location of the first person 202 in the vehicle 104 or the additional location of the second person 204 in the vehicle 104.

At 706, the audio input for at least one of the first microphone device or the second microphone device is adjusted based on whether the first person or the second person is a subject of a conversation of the audio call. For example, the audio playback manager 120 adjusts the audio input from the first microphone device 112 or the second microphone device 114 based on whether the first person 202 or the second person 204 is a subject of a conversation of the audio call. In some example implementations, the audio playback manager 120 mutes the first microphone device 112 when the first person 202 is not actively speaking. For example, the audio playback manager 120 detects when the first person 202 begins actively speaking and un-mutes the first microphone device 112. In some example implementations, the audio playback manager 120 determines whether the first person 202 or the second person 204 is relevant to the audio call. For example, the audio playback manager 120 uses a machine learning model trained on prior call history to determine whether the first person 202 or the second person 204 is relevant to the audio call. In some example implementations, the audio playback manager 120 adjusts the audio input 118 from at least one of the first microphone device 112 or the second microphone device 114 in response to a change in the audio call.

At 708, audio output from at least one of a first speaker device or a second speaker device is adjusted based on whether the first person or the second person is the subject of the conversation of the audio call. For example, the audio playback manager 120 adjusts audio output 116 from a first speaker device 108 or a second speaker device 110 based on whether the first person 202 or the second person 204 is the subject of the conversation of the audio call.

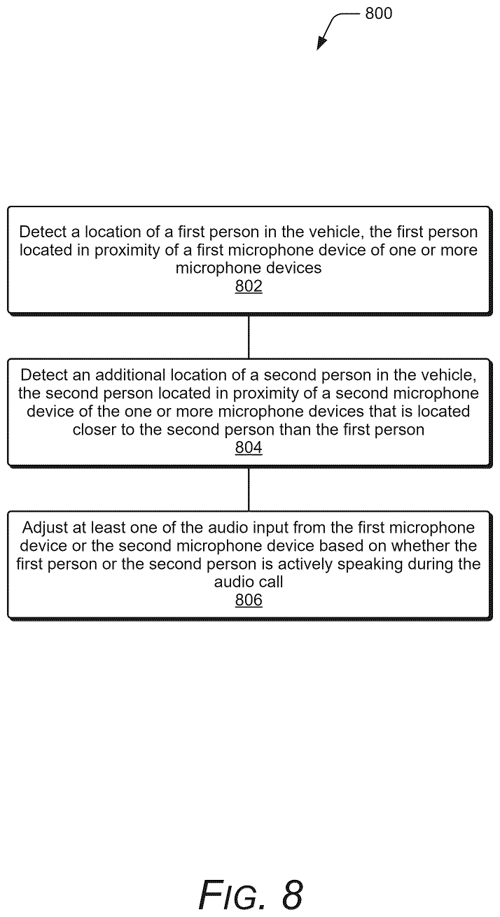

FIG. 8 illustrates example method(s) 800 for adjusting audio input in a vehicle. The order in which the method is described is not intended to be construed as a limitation, and any number or combination of the described method operations may be performed in any order to perform a method, or an alternate method.

At 802, a location of a first person in the vehicle is detected, the first person located in proximity of a first microphone device of the one or more microphone devices. For example, the audio playback manager 120 detects a location of a first person 202 in the vehicle 104, the first person 202 located in proximity of a first microphone device 112 of the one or more microphone devices.

At 804, an additional location of a second person in the vehicle is detected, the second person located in proximity of a second microphone device of the one or more microphone devices that is located closer to the second person than the first person. For example, the audio playback manager 120 detects an additional location of a second person 204 in the vehicle, the second person 204 located in proximity of a second microphone device 114 of the one or more microphone devices that is located closer to the second person 204 than the first person 202.

At 806, at least one of the audio inputs from the first microphone device or the second microphone device is adjusted based on whether the first person or the second person is actively speaking during the audio call. For example, the audio playback manager 120 adjusts at least one of the audio inputs from the first microphone device 112 or the second microphone device 114 based on whether the first person 202 or the second person 204 is actively speaking during the audio call. In some example implementations, the audio playback manager 120 mutes the first microphone device 112 when the first person 202 is not actively speaking. For example, the audio playback manager 120 detects when the first person 202 begins actively speaking and un-mutes the first microphone device 112. In some example implementations, the audio playback manager 120 further adjusts the audio input 118 for at least one of the first microphone device 112 or the second microphone device 114 in response to a change in the audio call.

FIG. 9 illustrates various components of an example device 900, which can implement aspects of the techniques and features for adjusting audio input in a vehicle, as described herein. The example device 900 may be implemented as any of the devices described with reference to the previous FIGS. 1-8, such as any type of a wireless device, mobile device, mobile phone, flip phone, client device, companion device, display device, tablet, computing, communication, entertainment, gaming, media playback, and/or any other type of computing and/or electronic device. For example, the vehicle audio system 102 described with reference to FIGS. 1-8 may be implemented as the example device 900.

The example device 900 can include various, different communication devices 902 that enable wired and/or wireless communication of device data 904 with other devices. The device data 904 can include data from any of the various devices and content that is generated, processed, determined, received, stored, and/or communicated from one computing device to another. Generally, the device data 904 can include any form of audio, video, image, graphics, and/or electronic data that is generated by applications executing on a device. The communication devices 902 can also include transceivers for cellular phone communication and/or for any type of network data communication.

The example device 900 can also include various, different types of data input/output (I/O) interfaces 906, such as data network interfaces that provide connection and/or communication links between the devices, data networks, and other devices. The data I/O interfaces 906 may be used to couple the device to any type of components, peripherals, and/or accessory devices, such as a computer input device that may be integrated with the example device 900. The I/O interfaces 906 may also include data input ports via which any type of data, information, media content, communications, messages, and/or inputs may be received, such as user inputs to the device, as well as any type of audio, video, image, graphics, and/or electronic data received from any content and/or data source.

The example device 900 includes a processor system 908 of one or more processors (e.g., any of microprocessors, controllers, and the like) and/or a processor and memory system implemented as a system-on-chip (SoC) that processes computer-executable instructions. The processor system 908 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 910. The example device 900 may also include any type of a system bus or other data and command transfer system that couples the various components within the device. A system bus can include any one or combination of different bus structures and architectures, as well as control and data lines.

The example device 900 also includes memory and/or memory devices 912 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 912 include volatile memory and non-volatile memory, fixed and removable media devices, and any suitable memory device or electronic data storage that maintains data for computing device access. The memory devices 912 can include various implementations of random-access memory (RAM), read-only memory (ROM), flash memory, and other types of storage media in various memory device configurations. The example device 900 may also include a mass storage media device.

The memory devices 912 (e.g., as computer-readable storage memory) provide data storage mechanisms, such as to store the device data 904, other types of information and/or electronic data, and various device applications 914 (e.g., software applications and/or modules). For example, an operating system 916 may be maintained as software instructions with a memory device 912 and executed by the processor system 908 as a software application. The device applications 914 may also include a device manager, such as any form of a control application, software application, signal-processing and control module, code that is specific to a particular device, a hardware abstraction layer for a particular device, and so on.

In this example, the device 900 includes an audio playback manager 918 that implements various aspects of the described features and techniques described herein. The audio playback manager 918 may be implemented with hardware components and/or in software as one of the device applications 914, such as when the example device 900 is implemented as the vehicle audio system 102 described with reference to FIGS. 1-8. An example of the audio playback manager 918 is the audio playback manager 120 implemented by the vehicle audio system 102, such as a software application and/or as hardware components in the mobile device. In implementations, the audio playback manager 918 may include independent processing, memory, and logic components as a computing and/or electronic device integrated with the example device 900.

The example device 900 can also include a microphone 920 and/or camera devices 922, as well as device sensors 924, such as may be implemented as components of an inertial measurement unit (IMU). The device sensors 924 may be implemented with various sensors, such as a gyroscope, an accelerometer, and/or other types of motion sensors to sense motion of the device. The device sensors 924 can generate sensor data vectors having three-dimensional parameters (e.g., rotational vectors in x, y, and z-axis coordinates) indicating location, position, acceleration, rotational speed, and/or orientation of the device. The example device 900 can also include one or more power sources 926, such as when the device is implemented as a wireless device and/or a mobile device. The power sources may include a charging and/or power system, and may be implemented as a flexible strip battery, a rechargeable battery, a charged super-capacitor, and/or any other type of active or passive power source.

The example device 900 can also include an audio and/or video processing system 928 that generates audio data for an audio system 930 and/or generates display data for a display system 932. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 900. Alternatively, the audio system and/or the display system are external, peripheral components to the example device.

Although implementations for adjusting audio input in a vehicle have been described in language specific to features and/or methods, the appended claims are not necessarily limited to the specific features or methods described. Rather, the specific features and methods are disclosed as example implementations for adjusting audio input in a vehicle, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

In some aspects, the techniques described herein relate to a vehicle audio system, including: at least one memory, and at least one processor coupled with the at least one memory and configured to cause the vehicle audio system in a vehicle to: detect a location of a first person in the vehicle, the first person located in proximity of a first microphone device configured to receive audio input for an audio call, detect an additional location of a second person in the vehicle, the second person located closer to a second microphone device than the first microphone device, the second microphone device configured to receive the audio input for the audio call, and adjust the audio input received by at least one of the first microphone device or the second microphone device based on whether the first person or the second person is actively speaking.

In some aspects, the techniques described herein relate to a vehicle audio system, wherein the at least one processor is configured to cause the vehicle audio system to mute the first microphone device when the first person is not actively speaking.

In some aspects, the techniques described herein relate to a vehicle audio system, wherein the at least one processor is configured to cause the vehicle audio system to detect when the first person begins actively speaking and un-mute the first microphone device.

In some aspects, the techniques described herein relate to a vehicle audio system, wherein the at least one processor is configured to cause the vehicle audio system to determine whether the first person or the second person is relevant to the audio call.

In some aspects, the techniques described herein relate to a vehicle audio system, wherein the at least one processor is configured to cause the vehicle audio system to use a machine learning model trained on prior call history to determine whether the first person or the second person is relevant to the audio call.

In some aspects, the techniques described herein relate to a vehicle audio system, wherein the at least one processor is configured to cause the vehicle audio system to use voice recognition to detect at least one of the location of the first person in the vehicle or the additional location of the second person in the vehicle.

In some aspects, the techniques described herein relate to a vehicle audio system, wherein the at least one processor is configured to cause the vehicle audio system to use facial recognition to detect at least one of the location of the first person in the vehicle or the additional location of the second person in the vehicle.

In some aspects, the techniques described herein relate to a vehicle audio system, wherein the at least one processor is configured to cause the vehicle audio system to further adjust at least one of the audio input from the first microphone device or the second microphone device in response to a change in the audio call.

In some aspects, the techniques described herein relate to a method, including: detecting a location of a first person in a vehicle, the first person located in proximity of a first microphone device to receive audio input from the first person for an audio call, detecting an additional location of a second person in the vehicle, the second person located in proximity of a second microphone device that is located closer to the second person than the first person to receive audio input from the second person for the audio call, adjusting the audio input for at least one of the first microphone device or the second microphone device based on whether the first person or the second person is a subject of a conversation of the audio call, and adjusting audio output from at least one of a first speaker device or a second speaker device based on whether the first person or the second person is the subject of the conversation of the audio call.

In some aspects, the techniques described herein relate to a method, further including muting the first microphone device when the first person is not actively speaking.

In some aspects, the techniques described herein relate to a method, further including detecting when the first person begins actively speaking and un-muting the first microphone device.

In some aspects, the techniques described herein relate to a method, further including determining whether the first person or the second person is relevant to the audio call.

In some aspects, the techniques described herein relate to a method, further including using a machine learning model trained on prior call history to determine whether the first person or the second person is relevant to the audio call.

In some aspects, the techniques described herein relate to a method, further including using voice recognition to detect at least one of the location of the first person in the vehicle or the additional location of the second person in the vehicle.

In some aspects, the techniques described herein relate to a method, further including using facial recognition to detect at least one of the location of the first person in the vehicle or the additional location of the second person in the vehicle.

In some aspects, the techniques described herein relate to a method, further including adjusting the audio input from at least one of the first microphone device or the second microphone device in response to a change in the audio call.

In some aspects, the techniques described herein relate to a system, including: one or more microphone devices in a vehicle and configured to receive audio input for an audio call, and a processor configured to implement an audio call manager to: detect a location of a first person in the vehicle, the first person located in proximity of a first microphone device of the one or more microphone devices, detect an additional location of a second person in the vehicle, the second person located in proximity of a second microphone device of the one or more microphone devices that is located closer to the second person than the first person, and adjust at least one of the audio input from the first microphone device or the second microphone device based on whether the first person or the second person is actively speaking during the audio call.

In some aspects, the techniques described herein relate to a system, wherein the audio call manager is configured to mute the first microphone device when the first person is not actively speaking.

In some aspects, the techniques described herein relate to a system, wherein the audio call manager is configured to detect when the first person begins actively speaking and un-mute the first microphone device.

In some aspects, the techniques described herein relate to a system, wherein the audio call manager is configured to further adjust the audio input for at least one of the first microphone device or the second microphone device in response to a change in the audio call.

1. A vehicle audio system, comprising:
at least one memory; and
at least one processor coupled with the at least one memory and configured to cause the vehicle audio system in a vehicle to:
detect a location of a first person in the vehicle, the first person located in proximity of a first microphone device configured to receive audio input for an audio call;
detect an additional location of a second person in the vehicle, the second person located closer to a second microphone device than the first microphone device, the second microphone device configured to receive the audio input for the audio call; and
adjust the audio input received by at least one of the first microphone device or the second microphone device based on whether the first person or the second person is actively speaking.

2. The vehicle audio system of claim 1, wherein the at least one processor is configured to cause the vehicle audio system to mute the first microphone device when the first person is not actively speaking.

3. The vehicle audio system of claim 2, wherein the at least one processor is configured to cause the vehicle audio system to detect when the first person begins actively speaking and un-mute the first microphone device.

4. The vehicle audio system of claim 1, wherein the at least one processor is configured to cause the vehicle audio system to determine whether the first person or the second person is relevant to the audio call.

5. The vehicle audio system of claim 4, wherein the at least one processor is configured to cause the vehicle audio system to use a machine learning model trained on prior call history to determine whether the first person or the second person is relevant to the audio call.

6. The vehicle audio system of claim 1, wherein the at least one processor is configured to cause the vehicle audio system to use voice recognition to detect at least one of the location of the first person in the vehicle or the additional location of the second person in the vehicle.

7. The vehicle audio system of claim 1, wherein the at least one processor is configured to cause the vehicle audio system to use facial recognition to detect at least one of the location of the first person in the vehicle or the additional location of the second person in the vehicle.

8. The vehicle audio system of claim 1, wherein the at least one processor is configured to cause the vehicle audio system to further adjust at least one of the audio input from the first microphone device or the second microphone device in response to a change in the audio call.

9. A method, comprising:
detecting a location of a first person in a vehicle, the first person located in proximity of a first microphone device to receive audio input from the first person for an audio call;
detecting an additional location of a second person in the vehicle, the second person located in proximity of a second microphone device that is located closer to the second person than the first person to receive audio input from the second person for the audio call;
adjusting the audio input for at least one of the first microphone device or the second microphone device based on whether the first person or the second person is a subject of a conversation of the audio call; and
adjusting audio output from at least one of a first speaker device or a second speaker device based on whether the first person or the second person is the subject of the conversation of the audio call.

10. The method of claim 9, further comprising muting the first microphone device when the first person is not actively speaking.

11. The method of claim 10, further comprising detecting when the first person begins actively speaking and un-muting the first microphone device.

12. The method of claim 9, further comprising determining whether the first person or the second person is relevant to the audio call.

13. The method of claim 12, further comprising using a machine learning model trained on prior call history to determine whether the first person or the second person is relevant to the audio call.

14. The method of claim 9, further comprising using voice recognition to detect at least one of the location of the first person in the vehicle or the additional location of the second person in the vehicle.

15. The method of claim 9, further comprising using facial recognition to detect at least one of the location of the first person in the vehicle or the additional location of the second person in the vehicle.

16. The method of claim 9, further comprising adjusting the audio input from at least one of the first microphone device or the second microphone device in response to a change in the audio call.

17. A system, comprising:
one or more microphone devices in a vehicle and configured to receive audio input for an audio call; and
a processor configured to implement an audio call manager to:
detect a location of a first person in the vehicle, the first person located in proximity of a first microphone device of the one or more microphone devices;
detect an additional location of a second person in the vehicle, the second person located in proximity of a second microphone device of the one or more microphone devices that is located closer to the second person than the first person; and
adjust at least one of the audio input from the first microphone device or the second microphone device based on whether the first person or the second person is actively speaking during the audio call.

18. The system of claim 17, wherein the audio call manager is configured to mute the first microphone device when the first person is not actively speaking.

19. The system of claim 18, wherein the audio call manager is configured to detect when the first person begins actively speaking and un-mute the first microphone device.

20. The system of claim 17, wherein the audio call manager is configured to further adjust the audio input for at least one of the first microphone device or the second microphone device in response to a change in the audio call.
